(19) United States
(12) Patent Application Publication
(10) Pub. No.: US 2011/0240478 A1
(43) Pub. Date: Oct. 6, 2011

(54) MICROMETER-SCALE OR NANOMETER=SCALE SPATIALLY CONTROLLED INCORPORATION OF PARTICLES IN A CONDUCTING SURFACE LAYER OF A SUPPORT

(76) Inventors: Massimiliano Cavallini, Vergato (Bo) (IT); Cristiano Albonetti, Casola Val Senio ( Ra) (IT)

(21) Appl. No.: 12/998,258

(22) PCT Filed: Sep. 25, 2009
(86) PCT No.: PCT/EP2009/062473

§ 371 Date: Jun. 16, 2011

(30) Foreign Application Priority Data
Sep. 30, 2008 (IT) MI2008AOO1734

(51) Int. Cl. C25D 15/00; B82Y 40/00

(52) U.S. Cl. 205/109; 977/700; 977/773

(57) ABSTRACT

A process for incorporating one or more particles in a conducting or semiconducting surface layer of a surface layer of the support, which comprises the steps of positioning one or more particles on the surface of the conducting surface layer and applying an electrical potential between the surface of the conducting surface layer and a second conducting surface, in an environment that contains an electrolyte, producing a modification of the chemical and/or physical state of the surface layer of the support and/or of the surface of the surface layer of the support and/or of the particle and incorporation of the particle or particles on the surface of the surface layer of the support.

### TECHNICAL FIELD

The present invention relates to a process for incorporation, controlled on a micrometer or nanometer scale, of particles and/or molecules and/or polymers in a surface layer of a support.

### BACKGROUND ART

Traditional incorporation, also known as embedding, is based on the incorporation of objects of variable geometric size and chemical nature in supports made of material having a different chemical nature (for example thin films), in order to modify their chemical-physical properties.

Traditional incorporation methods are currently based on:

a) chemical decomposition by irradiation of precursors dispersed beforehand in matrices or supports [1, 2];

b) subsequent depositions in which first the particles to be incorporated are deposited on the substrate and then the particles are covered with an additional deposition of a material that is identical or different with respect to the substrate [3];

c) incorporation in prefabricated thin films of polymer directly by evaporation (diffusion of the particles within the polymer) [4];

d) mixing in a polymeric solution of the particles and subsequent deposition by drop casting and/or by spin coating [5].

Some examples of this process are:

1) microcrystallites of silicon (Si) immersed in a polysilane matrix [1]. The spatial distance between the microcrystallites adjusts the light emission in the band of visible light wavelengths;

2) groups of atoms of silver (Ag) incorporated in a glass matrix [2]. The presence of the fragments modifies the visible light absorption properties;

3) incorporation of spherical nanoparticles of silver deposited on a surface of Si and covered by an additional layer of Si [3]. The two-dimensional layer of nanoparticles produces an anisotropy in the emission of light toward the infrared;

4) spherical nanoparticles of gold (Au) immersed in a thin film of polystyrene [4]. The presence of the nanoparticles modifies the viscoelastic properties of the polystyrene film and modifies its chemical-physical properties (for example the glass transition temperature);

5) nanometer-size filaments of nickel (Ni) incorporated in a polycarbonate matrix [5]. The magnetic properties of the filaments exhibit a dependency on the arrangement that they assume within the matrix.

The results described in the above cited examples demonstrate the effectiveness of incorporation in modifying the chemical-physical properties of materials but, at the same time, point out the shortcoming, in currently used methods, in controlling the spatial arrangement of the incorporated objects.

The present invention seeks to obviate this shortcoming by using local oxidation techniques [6,7]. Such techniques are similar to conventional electrochemical anode oxidation [8], but with the only difference that the electrochemical process occurs in the confined space between an electrically conducting surface (electrode) and one or more nanometer-size protrusions which are electrically conducting and act as a counter-electrode. The electrolyte consists of a solvent that is adsorbed on the surface of the electrode and the quantity of solvent that is deposited is determined by the partial pressure of the solvent in the controlled environment in which the vapors of the solvent are diffused. To control the process it is therefore necessary to work in an environment with a suitable partial pressure of the solvent (which in the case of water is constituted by relative humidity). When the electrode and the counter-electrode are placed in contact, a meniscus is formed between them which acts as an electrolyte, thus completing the formation of a typical electrochemical cell (electrode-electrolyte-counter-electrode), but of nanometer size.

The process can be of the serial type, using for example a conducting AFM tip as a counter-electrode, or of the parallel type, using a die of any material that has a conducting surface. FIG. 1 illustrates the diagram of the process applied to silicon.

A local electrochemistry process is already known from Italian Patent 1341242, and from WO 02/003142 A3 and EP 1297387, “Electric microcontact printing method and apparatus”, and is shown in FIG. 1.

The electrochemically formed oxide is topographically in relief with respect to the non-oxidized surface and can be removed subsequently by chemical methods (in this case, depressed regions form at the previously oxidized regions with respect to the surface), allowing to produce three-dimensional patterns and structures. There are also applications in which the same process is used in reduction instead of oxidation [2].

### DISCLOSURE OF THE INVENTION

The aim of the present invention is to provide a method that allows to apply a local electrochemistry process in a confined space of micrometer and/or nanometer size in which there is a particle whose dimensions are comparable and/or smaller and allows to incorporate said particle on the surface due to the product of the electrochemical reaction. The advantages of this invention are therefore that it performs incorporation of the particle in a manner that is spatially controlled with a nanometer resolution, i.e. it incorporates the particles in specific regions of the surface, as a consequence of the electrochemical reaction. A further advantage of the present invention is control of the product of the electrochemical reaction, which can incorporate the particle completely or partially.

If partial covering occurs, said particle can be subjected to subsequent chemical and/or physical treatments and/or processes which can modify its functionality.

This aim and these objects are achieved by means of the process for incorporating one or more particles in a conducting or semiconducting surface layer of the support, which comprises the steps of positioning said one or more particles on the surface of said conducting surface layer and applying an electrical potential between said surface of said conducting surface layer and a second conducting surface, in an environment that contains an electrolyte, thus producing a modification of the chemical and/or physical state of said surface layer of the support and/or of said surface of said surface layer of the support and/or of said particle and incorporation of said particle or particles on said surface of said surface layer of the support.

This modification can be, for example, the alteration of the local electrochemical oxidation state of said surface layer of the support and/or of said surface of said surface layer of the support and/or of said particle.

One or both surfaces can be morphologically and/or chemically structured.

The second surface can be constituted for example by surfaces of dies with patterns in relief whose dimensions are comprised between 0.1 nanometers and 1 centimeter.

The second surface can also be constituted by probes or nanoprobes, in particular probes for Atomic Force Microscopy (AFM).

The particles can have dimensions comprised for example between 0.1 nm and 100 μm.

The particles can be inorganic, organic or hybrid, or mixtures of particles of any kind.

The particles can also be covered with an outer protective layer.

The particles can be for example magnetic and/or conducting and/or semiconducting and/or ferroelectric and/or piezoelectric.

In one embodiment of the present invention, the surface layer is made of silicon, the electrolyte is water, and the second surface is a metal.

### BRIEF DESCRIPTION OF THE DRAWINGS

The present invention will be described in greater detail with reference to the following figures:

FIG. 1. Schematic view of the conventional process of local nano-oxidation. (a) serial method, by means of an AFM tip; (b) parallel method by means of a die.

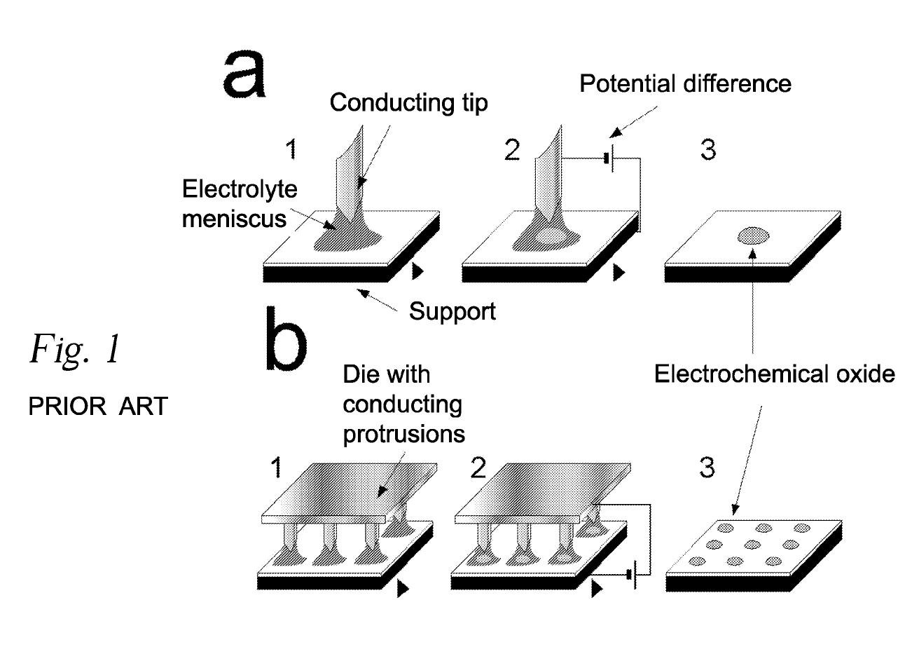

FIG. 2. Schematic view of the process for local nano-incorporation of the present invention.

FIG. 3. AFM image of two nanoparticles incorporated in strips of silicon oxide obtained by parallel local oxidation.

### WAYS OF CARRYING OUT THE FIGURES

The process according to the invention is a new application of the local electrochemistry process already performed serially with scanning probe microscopes (SPM) or, in a parallel manner, with dies [7]. By means of the local electrochemistry process it is possible to block on the surface of a substrate one or more particles of inorganic, organic or hybrid nature between the tip/die and the surface. In these conditions, the electrochemical process modifies chemically and/or physically the surface and/or the particle or particles, locking it/them, i.e., incorporating it/them in said surface.

The process according to the present invention can be applied on a micrometer or nanometer scale, using a local nano-electrochemical reaction and obtaining so-called nano-incorporation.

Examples of substrates that can be used in the present invention are silicon, silicon/carbon alloys, manganites, some metals, semiconductors and others.

Examples of electrolytes that can be used in the process of the present invention are water, either pure or containing dissolved salts, alcohols, hydrocarbons or other.

In a preferred embodiment of the invention, the layer is formed by silicon, the electrolyte is water and the second conducting surface is constituted by gold or another metal.

In other preferred embodiments of the present invention, substrate-electrolyte-second surface groups such as SiC/ethanol/platinum and La0.3Sr0.7Mn 03/methanol/silver are used.

The process according to the present invention occurs preferably in an environment that contains electrolyte vapors at such a partial pressure as to form a thin adsorbed layer of electrolyte on the surface of the substrate and/or on the counter-electrode. Said adsorbed layer forms the meniscus between the two conducting surfaces. Said electrolyte can also be deposited on one of the two surfaces as a thin film by using any method (for example condensation, drop-casting deposition, et cetera).

Deposition of the particles on the surface of the conducting supporting layer can be performed with any technique (for example deposition from a solution on a die and/or substrate) and is not the subject of this patent.

The process according to the invention has been demonstrated by using the surface of a silicon substrate (used as electrode), a conducting tip/die (used as a counter-electrode), particles of different material and shape, and by using as electrolyte the water condensed on the surfaces of the tip/die and of the electrode, in an environment in which relative humidity exceeded the threshold of 90% (it should be noted that the quantity of water adsorbed on the surfaces depends on the shape and chemical nature of the materials used as electrode and counter-electrode and on the nature of the particle).

By applying between the electrode and the counter-electrode a voltage that is equal to, or greater than, the threshold voltage needed to activate the electrochemical oxidation process (or, in other cases, reduction process) of said surface, the electrochemical oxidation process is triggered which forms silicon oxide. It grows around and/of above and/or below the particle, incorporating it within said oxide and thus providing local incorporation of said particle or particles (the threshold voltage depends on the specific conditions of the process, in the particular example it is equal to 36 V).

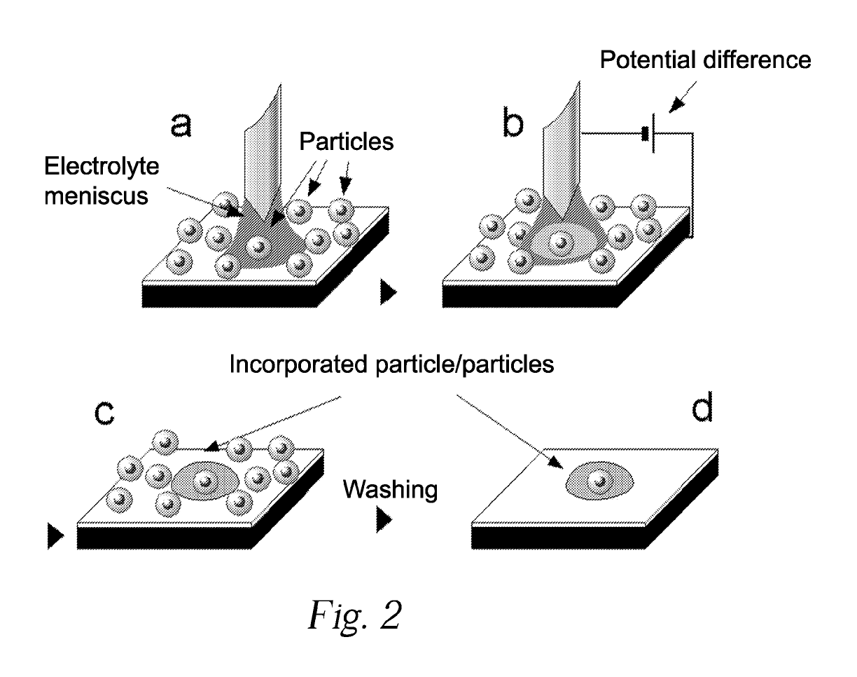

FIG. 2 illustrates the diagram of the process.

The effectiveness of nano-incorporation has been demonstrated by using particles of different chemical nature (gold, ferrite, cobaltite) and of variable size (to a few tens of nanometers), but in principle the process can be extended to any type of particle and/or molecule and/or atom.

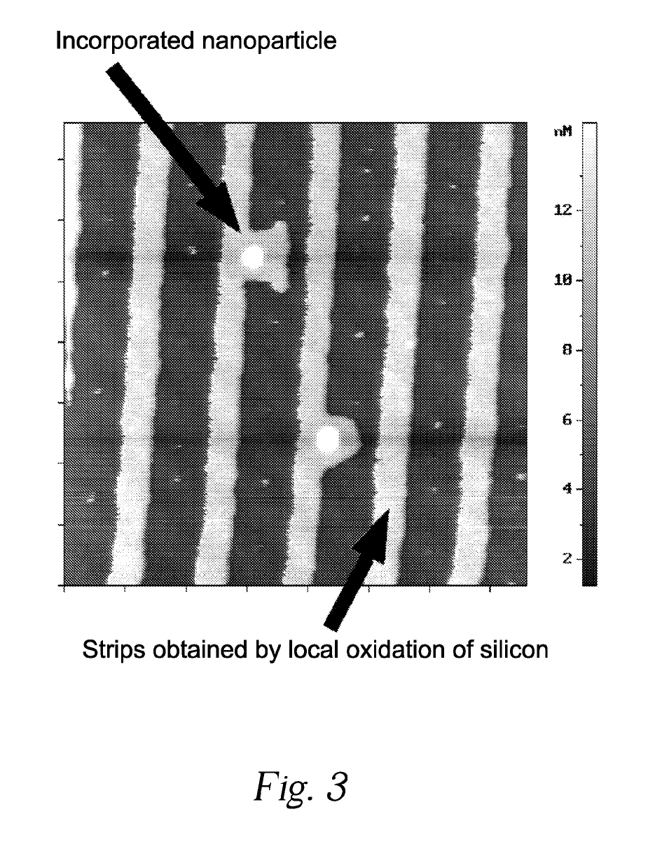

FIG. 3 illustrates an example of two gold nanoparticles captured during the nano-incorporation process.

In the case of electrochemical instability of the particle (i.e., total or partial decomposition of the particle), the application of the process can require the use of particles covered by a protective layer and/or a sacrificial layer (i.e., a chemical enclosure that covers the particle and can undergo an electrochemical reaction without compromising the functionality and/or properties of the particle enclosed therein).

In principle, the process: can be extended to multifunctional polymers and molecules; can be integrated with the main known unconventional nano-manufacturing techniques and can be integrated and is compatible with current silicon technology.

The process according to the present invention can be also utilized in two variations:

1) The particles can be deposited beforehand on the die and then transferred onto the surface as a consequence of the application of the process;

2) After incorporating a first time one type of nanoparticle, it is possible to deposit and incorporate a second, third, or any layer of nanoparticles can be deposited and incorporated, repeating the local incorporation process by using a die with patterns that are identical or different with respect to the first one. Said multiple process may require, or not, an intermediate operation for alignment of the die used in the steps that follow the first nano-incorporation.

The main applications of the nano-incorporation process are: patterning, floating gate, information storage, sensors, microelectronics and nano electronics.

The disclosures in Italian Patent Application No. MI2008A001734 from which this application claims priority are incorporated herein by reference.

### REFERENCES

[1] Takagi H, Ogawa H, Yamazaki Y, Ishizaki A and Nakagiri T 1990 App. Phys. Lett. 56 (24) 2379

[2] Gonella F, Mattei G, Mazzoldi P, Cattaruzza E, and Arnold G W 1990 App. Phys. Lett 69(20) 3101

[3] Martens H, Verhoeven J and Polman A 1990 App. Phys. Lett. 85(8) 1317

[4] Teichroeb J H and Forrest J A 2003 Phys. Rev. Lett. 91(1) 016104

[5] Dubois S and Colin J 2000 Phys. Rev. B 61(21) 14315

[6] on book: “Scanning Probe Microscopies Beyond Imaging: Manipulation of Molecules and Nanostructures” edited by Wiley-VCH 2006. Chapter 10. C. Albonetti, R. Kshirsagar, M. Cavallini, F. Biscarini.

[7] PCT patent application WO2007129355 “Large area fabrication method based on the local oxidation of silicon and/or different materials on micro- and nano-scale”

[8] Hung T F, Wong H, Cheng Y C and Pun C K 1991 J. Electrochem. Soc. 138(12) 3747-50.

1. A method for incorporating one or more particles in a conducting or semiconducting surface layer of a surface layer of a support, which comprises the steps of positioning said one or more particles on the surface of said conducting surface layer and applying an electrical potential between said surface of said conducting surface layer and a second conducting surface, in an environment that contains an electrolyte, producing a modification of the chemical and/or physical state of said surface layer of the medium and/or of said surface of said surface layer of the support and/or of said particle and incorporation of said particle or particles on said surface of said surface layer of the support.

2. The method according to claim 1, wherein said modification is the alteration of the local electrochemical oxidation state of said surface layer of the support and/or of said surface of said surface layer of the support and/or of said particle.

3. The method according to claim 1, wherein one or both of said surfaces are structured morphologically and/or chemically.

4. The method according to claim 1, wherein said second surface is defined by surfaces of dies with patterns in relief with a size comprised between 0.1 nanometers and 1 centimeter.

5. The method according to claim 1, wherein said second surface is defined by probes or nanoprobes, particularly AFM nanoprobes.

6. The method according to claim 1, wherein said particles have dimensions comprised between 0.1 nm and 100 μm.

7. The method according to claim 1, wherein said particles are of an inorganic, organic or hybrid nature or are mixtures of particles of any nature.

8. The method according to claim 1, wherein said particles are covered with an outer protective layer.

9. The method according to claim 1, wherein said particles are magnetic and/or conducting and/or semiconducting and/or ferroelectric and/or piezoelectric.

10. The method according to claim 1, wherein said surface layer is made of silicon, said electrolyte is water, and said second surface is a metal.

11. A method for incorporating one or more particles in a conducting or semiconducting surface layer of a surface layer of the support, which comprises the steps of positioning said one or more particles on the surface of said conducting surface layer and applying an electrical potential between said surface of said conducting surface layer and a second conducting surface, in an environment that contains an electrolyte, producing a modification of the chemical and/or physical state of said surface layer of the medium and/or of said surface of said surface layer of the support and/or of said particle and incorporation of said particle or particles on said surface of said surface layer of the support; said second surface being defined by probes or nanoprobes.

12. The method according to claim 11, wherein said probes are AFM nanoprobes.

13. The method according to claim 11, wherein said particles are covered with an outer protective layer.

14. A method for incorporating one or more particles in a conducting or semiconducting surface layer of a surface layer of the support, which comprises the steps of positioning said one or more particles on the surface of said conducting surface layer and applying an electrical potential between said surface of said conducting surface layer and a second conducting surface, in an environment that contains an electrolyte, producing a modification of the chemical and/or physical state of said surface layer of the medium and/or of said surface of said surface layer of the support and/or of said particle and incorporation of said particle or particles on said surface of said surface layer of the support; said particles being covered with an outer protective layer.

15. The method according to claim 14, wherein said second surface being defined by probes or nanoprobes.

16. The method according to claim 15, wherein said probes are AFM nanoprobes.

17. A method for incorporating one or more particles in a conducting or semiconducting surface layer of a surface layer of the support, which comprises the steps of positioning said one or more particles on the surface of said conducting surface layer and applying an electrical potential between said surface of said conducting surface layer and a second conducting surface, in an environment that contains an electrolyte, producing a modification of the chemical and/or physical state of said surface layer of the medium and/or of said surface of said surface layer of the support and/or of said particle and incorporation of said particle or particles on said surface of said surface layer of the support; wherein said second surface being defined by probes or nanoprobes, particularly AFM nanoprobes, and said particles being covered with an outer protective layer.
